(19) United States
(12) Patent Application Publication
(10) Pub. No.: US 2005/0117536 A1
(43) Pub. Date: Jun. 2, 2005

(54) System and method for transmitting and receiving resource allocation information in a wireless communication system

(75) Inventors: Sung-Hyun Cho, Seoul (KR); Ki-Ho Kim, Seoul (KR); Sang-Boh Yun, Seongnam-si (KR); Won-Hyoung Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/971,492

(22) Filed: Oct. 22, 2004

(30) Foreign Application Priority Data
Oct. 23, 2003 (KR) 74304/2003

(51) Int. Cl. H04Q 7/00

(52) U.S. Cl. 370/328

(57) ABSTRACT

In a wireless communication system, a BS transmits first resource allocation information common to all MSs at every predetermined first time point of a first period, and transmits second resource allocation information dedicated to each of the MSs at every predetermined second time point of a second period shorter than the first period, within the first period. An MS receives the first resource allocation information at every first predetermined time point of the first period, and receives second resource allocation information dedicated to the MS at a second time point of the second period predetermined for the MS by analyzing the first resource allocation information.

### PRIORITY

This application claims priority under 35 U.S.C. § 119 to an application entitled “System and Method for Transmitting/Receiving Resource Allocation Information in a Wireless Communication System” filed in the Korean Intellectual Property Office on Oct. 23, 2003 and assigned Ser. No. 2003-74304, the contents of which are incorporated herein by reference.

### BACKGROUND OF THE INVENTION

1. Field of the Invention

The present invention relates generally to a wireless communication system, and in particular, to a system and method for transmitting and receiving resource allocation information in a multi-level structure.

2. Description of the Related Art

With the introduction of a cellular mobile communication system in the U.S. in the late 1970's, Korea started to provide a voice communication service in a first generation (1G) analog mobile communication system, AMPS (Advanced Mobile Phone Service). In the mid 1990's, Korea developed a second generation (2G) mobile communication system, CDMA (Code Division Multiple Access) to provide voice and low-speed data services.

In the late 1990's, Korea partially developed a third generation (3G) mobile communication system, IMT-2000 (International Mobile Telecommunication-2000), aiming at advanced wireless multimedia service, worldwide roaming, and high-speed data service. The 3G mobile communication system was developed specifically to transmit data at high rate along with the rapid increase of serviced data amount.

Currently, the 3G mobile communication system is evolving to a fourth generation (4G) mobile communication system. The 4G mobile communication system is under standardization for the purpose of efficient interworking and integrated service between a wired communication network and a wireless communication network beyond simple wireless communication service, which the previous-generation mobile communication systems provide. Accordingly, it follows that a technology for transmitting a large volume of data at a capacity level available in the wired communication network must be developed for the wireless communication network.

The development of mobile communication technology has driven the service focus, shifting from the voice-centered service to the data-centered service. As such, mobile communication systems have been developed from circuit switching-based networks to packet switching-based networks. A packet switching-based system allocates a channel only in the presence of data to be transmitted, thereby causing frequent channel accesses and channel releases.

A circuit switching-based system allocates a predetermined volume of resources to a particular user while a session is maintained, that is, in a static manner. This static resource allocation is relatively simple. Alternatively, the packet switching-based system dynamically assigns resources during a session. The dynamic resource allocation is very complex compared to the static resource allocation. As a result, the amount of resource allocation information transmitted periodically or non-periodically to users increases.

Obviously, the recent trend of wireless communication systems is toward high-speed wireless communication service. The high-speed wireless communication system designs frame or slots at or below an msec level and thus a scheduling period at or below an msec level in correspondence with the frame or slot size. To maximize system throughput, the high-speed wireless communication system introduces dynamic channel allocation techniques including AMC (Adaptive Modulation and Coding) and DCA (Dynamic Channel Allocation). It also defines variable resource assignment units for the dynamic resource allocation.

The AMC is a scheme in which an MCS (Modulation and Coding Scheme) level is assigned to a mobile station (MS) based on a feed-back CQI (Channel equality Information) to thereby maximize transmission efficiency according to channel status. The DCA also maximizes the transmission efficiency according to channel status by adaptively allocating a channel to an MS according to the channel status.

Use of the dynamic resource allocation techniques increases the amount of periodical or non-periodical resource allocation information, i.e., scheduling information. Especially in a communication system that periodically transmits a MAP message including scheduling information (i.e. resource allocation information) on the downlink, such as a Hiperlan/2 or IEEE (Institute of Electrical and Electronics Engineers) 802.16 communication system, the increase of the resource allocation information and the number of transmission occurrences may cause a decrease of system throughput.

To implement the dynamic resource allocation techniques, a scheduler (i.e., a base station (BS)) receives CQIs from subscriber users in every scheduling period. As the scheduling period becomes shorter, a CQI feedback period for each MS becomes shorter. As a result, overhead for resource allocation increases. The amount of a CQI from each MS becomes even higher especially in a MIMO (Multi-Input and Multi-Output) communication system using a plurality of transmit antennas and a plurality of receive antennas.

As the BS transmits the resource allocation information periodically or non-periodically, normal signal transmission and reception is possible as far as the MS receives the resource allocation information normally. Therefore, the MS continuously monitors to receive the resource allocation information. The continuous monitoring increases power consumption in the MS.

### SUMMARY OF THE INVENTION

An object of the present invention is to substantially solve at least the above problems and/or disadvantages and to provide at least the advantages below. Accordingly, an object of the present invention is to provide a system and method for transmitting and receiving resource allocation information in a multilevel structure in a wireless communication system.

Another object of the present invention is to provide a system and method for transmitting and receiving resource allocation information of a minimum size in a wireless communication system.

A further object of the present invention is to provide a system and method for transmitting and receiving resource allocation information with minimum power consumption in an MS in a wireless communication system.

Still another object of the present invention is to provide a system and method for transmitting and receiving resource allocation information with a minimum CQI feedback load in an MS in a wireless communication system.

The above objects are achieved by providing a system and method for transmitting and receiving resource allocation information in a wireless communication system.

According to one aspect of the present invention, in a system for transmitting/receiving resource allocation information in a wireless communication system, a BS transmits first resource allocation information common to all MSs at every predetermined first time point of a first period, and transmits second resource allocation information dedicated to each of the MSs at every predetermined second time point of a second period shorter than the first period, within the first period. An MS receives the first resource allocation information at every first predetermined time point of the first period, and receives second resource allocation information dedicated to the MS at a second time point of the second period predetermined for the MS by analyzing the first resource allocation information.

According to another aspect of the present invention, in a method of transmitting resource allocation information in a wireless communication system, a BS transmits first resource allocation information at every predetermined first time point of a first period. The first resource allocation information is common to all MSs. The BS transmits second resource allocation information at every predetermined second time point of a second period within the first period. The second resource allocation information is dedicated to each of the MSs at a second time point of the second period predetermined for the MS and the second period is shorter than the first period.

According to a further aspect of the present invention, in a method of receiving resource allocation information in a wireless communication system, an MS receives first resource allocation information common to all MSs at every first predetermined time point of a first period, and receives second resource allocation information dedicated to the MS at a predetermined second time point of a second period among second time points of the second period defined within the first period by analyzing the first resource allocation information. Here, the second period is shorter than the first period.

### BRIEF DESCRIPTION OF THE DRAWINGS

The above and other objects, features, and advantages of the present invention will become more apparent from the following detailed description when taken in conjunction with the accompanying drawings in which:

FIG. 1 schematically illustrates a hierarchical frame structure in a wireless communication system according to an embodiment of the present invention;

FIG. 2 schematically illustrates the structure of a conventional MAP message for a wireless communication system;

FIG. 3 schematically illustrates multilevel MAP message transmission;

FIG. 4 is a flowchart illustrating an operation in a BS according to the present invention; and

FIG. 5 is a flowchart illustrating an operation in an MS according to the present invention

### DETAILED DESCRIPTION OF THE PREFERRED EMBODIMENT

Preferred embodiments of the present invention will be described in detail herein below with reference to the accompanying drawings. In the following description, well-known functions or constructions are not described in detail since they would obscure the invention in unnecessary detail.

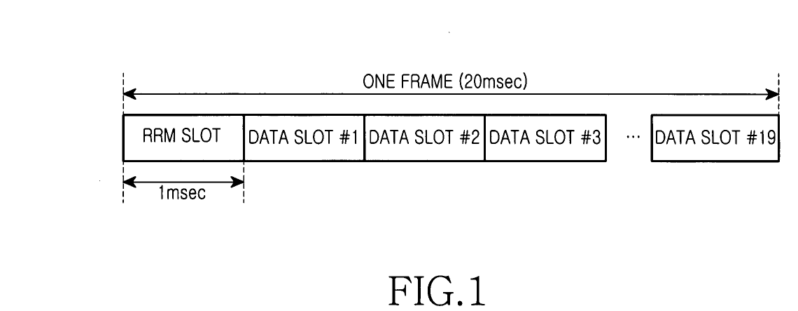

FIG. 1 schematically illustrates a hierarchical frame structure in a wireless communication system according to an embodiment of the present invention. Referring to FIG. 1, one frame comprises 20 slots, each slot having a duration of 1 msec. Therefore, one frame has a duration of 20 msec. The frame includes one RRM (Radio Resource Management) slot and 19 data slots, data slot #1 to data slot #19. The RRM slot delivers control information and the data slots deliver data. Hierarchic configuring of a frame, that is, slots and a set of slots as a frame, as illustrated in FIG. 1 enables multilevel transmission and reception of resource allocation information according to the present invention. The multilevel resource allocation information transmission and reception in the hierarchical frame structure will be described in more detail herein below.

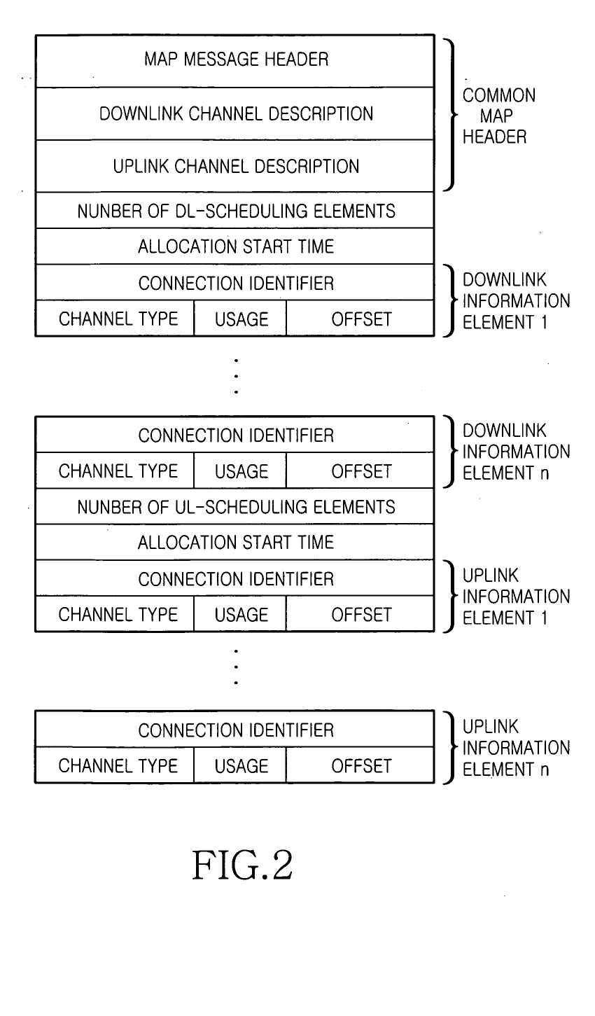

FIG. 2 schematically illustrates a structure of a conventional MAP message for a wireless communication system. Referring to FIG. 2, the MAP message is divided into a header (COMMON MAP HEADER) and an information element (IE) area. The IE area is further branched into a downlink IE area and an uplink IE area.

The COMMON MAP HEADER comprises a MAP MESSAGE HEADER, a DOWNLINK CHANNEL DESCRIPTION, and an UPLINK CHANNEL DESCRIPTION. The MAP MESSAGE HEADER includes common header information about conventional MAC (Medium Access Control) PDUs (Protocol Data Units). The DOWNLINK CHANNEL DESCRIPTION includes information indicating the manner in which downlink data slots are grouped and information about an MCS level for applying AMC to the grouped downlink data slots. The UPLINK CHANNEL DESCRIPTION includes information indicating the manner in which uplink data slots are grouped and information about an MCS level for applying AMC to the grouped uplink data slots.

The downlink IE area includes a NUMBER OF DL-SCHEDULING ELEMENTS, an ALLOCATION START TIME, a CONNECTION IDENTIFIER (CID), a CHANNEL TYPE, a USAGE, and an OFFSET.

The NUMBER OF DL-SCHEDULING ELEMENTS indicates the number of DOWNLINK IEs. The ALLOCATION START TIME indicates an action time, that is, a slot in which downlink resource allocation starts. The CID identifies a current connected session, that is, a corresponding MS. The CHANNEL TYPE indicates assigned data slots, that is, the type of an assigned data channel. The USAGE indicates the usage of the assigned data channel. The OFFSET indicates the number of assigned data slots counted from the action time set in the ALLOCATION START TIME.

The uplink IE area includes a NUMBER OF UL-SCHEDULING ELEMENTS, an ALLOCATION START TIME, a CONNECTION IDENTIFIER (CID), a CHANNEL TYPE, a USAGE, and an OFFSET.

The NUMBER OF UL-SCHEDULING ELEMENTS indicates the number of UPLINK IEs. The ALLOCATION START TIME indicates an action time, that is, a slot in which uplink resource allocation starts. The CID identifies a current connected session, that is, a corresponding MS. The CHANNEL TYPE indicates assigned data slots, that is, the type of an assigned data channel. The USAGE indicates the usage of the assigned data channel. The OFFSET indicates the number of assigned data slots counted from the action time set in the ALLOCATION START TIME.

As described above, because the MAP message is configured to include the whole resource allocation information, an increase in scheduling information or resource allocation information increases the amount of the resource allocation information in the MAP message, for example, in a Hiperlan/2 or IEEE 802.16 communication system. Particularly, using the dynamic channel allocation techniques including AMC and DCA considerably increases the amount of the resource allocation information, thereby decreasing system throughput. Moreover, because the MAP message is transmitted to MSs periodically, the MSs monitor for MAP message reception in every MAP message transmission period. Therefore, power consumption is increased.

Therefore, the present invention generates resource allocation information at each of multiple levels in order to prevent the decrease of system throughput caused by the increase of resource allocation information and minimize power consumption involved in receiving the resource allocation information in MSs. The transmission period and amount of resource allocation information are set differently for each level.

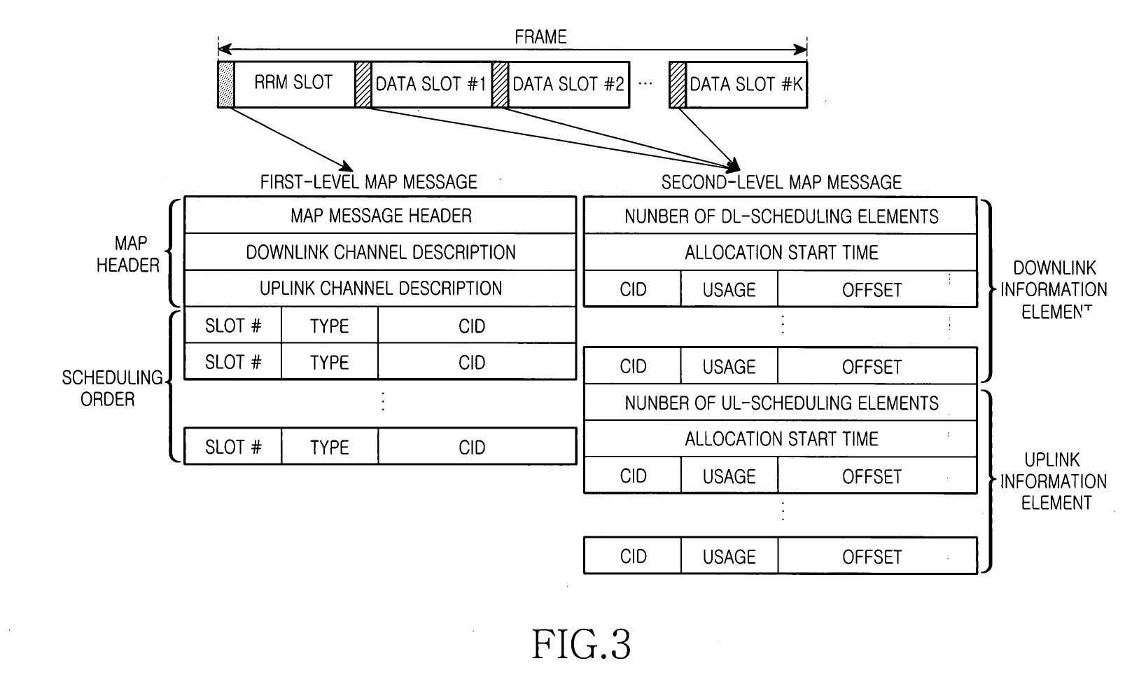

FIG. 3 schematically illustrates multilevel transmission of a MAP message according to the embodiment of the present invention. However, before describing FIG. 3, it should be noted that the multilevel transmission of resource allocation information according to the present invention is closely related to the hierarchical frame structure for the wireless communication system. The number of multiple levels is determined according to the hierarchical frame structure.

As described earlier with reference to FIG. 1, if the hierarchical frame structure includes a layer of slots and a layer of a frame including the slots, the number of multiple levels is 2. Although not shown, if the hierarchical frame structure includes a layer of frames and a layer of a super frame including the frames, the multilevel number is also 2.

If the hierarchical frame structure includes a layer of slots, a layer of frames each having the slots, and a layer of a super frame having the frames, the number of multiple levels is 3. Because the number of multiple levels depends on the frame structure, it obviously varies with a system situation in the wireless communication system.

Referring to FIG. 3, it is assumed that the hierarchical frame structure is 2-layered, having a layer of a frame and a layer of slots in the frame and thus the number of multiple levels for transmitting the resource allocation information is 2. Therefore, a first-level MAP message for transmitting first-level resource allocation information and a second-level MAP message for transmitting second-level resource allocation information can be formed.

The first-level MAP message is transmitted only at the start point of a frame, specifically, the start point of an RRM slot, whereas the second-level MAP message is transmitted only at the start point of each data slot. The first-level and second-level MAP messages have different transmission periods. The transmission period of the first-level MAP message is one frame, and that of the second-level MAP message is one slot. When the hierarchical frame structure includes a layer of a super frame and a layer of frames in the super frame, the first-level MAP message is transmitted at the start point of the super frame and the second-level MAP message is transmitted at the start point of each frame.

If the frame structure has three layers, a super frame, frames in the super frame, and slots in each of the frames, the number of multiple levels is 3. Therefore, first-level, second-level, and third-level MAP messages can be formed to deliver first-level, second-level, and third-level resource allocation information, respectively. The first-level, second-level, and third-level MAP messages are transmitted respectively at the start point of the super frame, the start point of each of the frames, and at the start point of each of the slots in each frame.

The first-level MAP message illustrated in FIG. 3 is transmitted at the start point of the frame, specifically, at the start point of the RRM slot. A scheduling order is set on a frame basis and the first-level MAP message indicates which slot has resource allocation information for an MS. That is, the first-level MAP message includes information indicating MSs to be assigned to uplink or downlink data channels in particular slots.

The first-level MAP message comprises a MAP HEADER and a SCHEDULING ORDER. The MAP HEADER includes a MAP MESSAGE HEADER, a DOWNLINK CHANNEL DESCRIPTION, and an UPLINK CHANNEL DESCRIPTION. The MAP MESSAGE HEADER includes common header information about typical MAC PDUs. The DOWNLINK CHANNEL DESCRIPTION includes information indicating the manner in which downlink data slots are grouped and information about an MCS level for applying AMC to the grouped downlink data slots. The UPLINK CHANNEL DESCRIPTION includes information indicating the manner in which uplink data slots are grouped and information about an MCS level for applying AMC to the grouped uplink data slots.

The SCHEDULING ORDER includes SLOT #, TYPE, and CID.

The SLOT # indicates a particular slot, the TYPE indicates a slot assigned by the slot set in the SLOT #, that is, the type of an assigned channel, and the CID identifies an MS which is to receive the second-level MAP message in the slot set in the SLOT #, for downlink channel reception.

The BS transmits the first-level MAP message at the start of the frame and each MS also receives the first-level MAP message at the start of the frame. The MS reads the first-level MAP message and determines a slot in which it is to receive the second-level MAP message. Because there is no need for monitoring MAP messages from the BS continuously in the MS, power consumption in the MS is minimized.

The second-level MAP message comprises a downlink IE area and an uplink IE area. The downlink IE area includes a NUMBER OF DL-SCHEDULING ELEMENTS, an ALLOCATION START TIME, a CID, a USAGE, and an OFFSET.

The NUMBER OF DL-SCHEDULING ELEMENTS indicates the number of DOWNLINK IEs. The ALLOCATION START TIME indicates an action time, that is, a slot in which downlink resource allocation starts. The CID identifies a current connected session, that is, a corresponding MS. The USAGE indicates the usage of an assigned data channel. The OFFSET indicates the number of assigned data slots counted from the action time set in the ALLOCATION START TIME.

The uplink IE area includes a NUMBER OF UL-SCHEDULING ELEMENTS, an ALLOCATION START TIME, a CID, a USAGE, and an OFFSET. The NUMBER OF UL-SCHEDULING ELEMENTS indicates the number of UPLINK IEs. The ALLOCATION START TIME indicates an action time, that is, a slot in which uplink resource allocation starts. The CID identifies a current connected session, that is, a corresponding MS. The USAGE indicates the usage of the assigned data channel. The OFFSET indicates the number of assigned data slots counted from the action time set in the ALLOCATION START TIME.

An MS, which determines a slot to receive the second-level MAP message from the first-level MAP message, receives the second-level MAP message in the determined slot and detects resource allocation information. As a result, power consumption is minimized.

While the first-level and second-level MAP messages are formed to transmit resource allocation information in the embodiment of the present invention, if more levels are defined and MAP messages are formed in correspondence with the levels, a MAP message for each level has less information. Therefore, system throughput further increases.

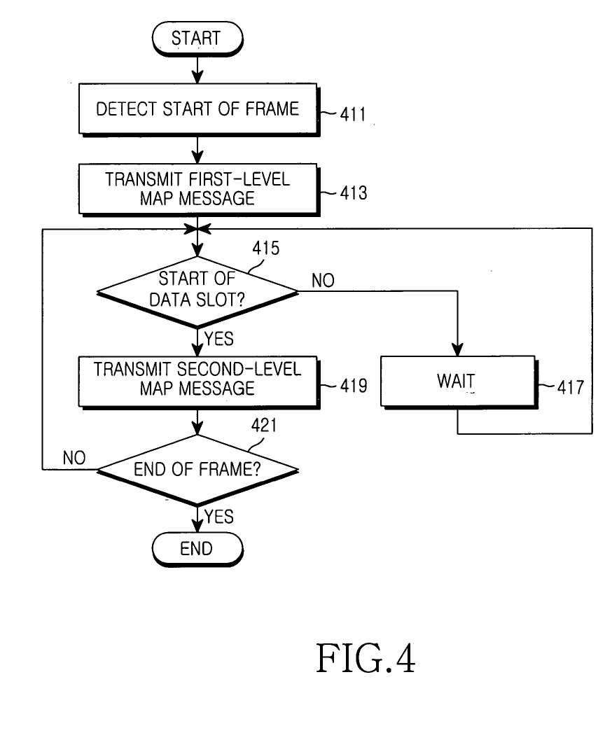

FIG. 4 is a flowchart illustrating an operation in a BS according to the embodiment of the present invention. The BS operation is repeated for each frame. For conciseness, an operation for one frame will be described.

Referring to FIG. 4, the BS detects the start point of a frame, that is, the start point of an RRM slot in step 411 and transmits the first-level MAP message at the start of the frame in step 413. The information of the first-level MAP message has been described in detail with reference to FIG. 3.

In step 415, the BS determines whether a data slot starts. When it is not the start point of a data slot, the BS waits for the start point of the data slot in step 417. At the start point of the data slot, the BS transmits the second-level MAP message in step 419. The information of the second-level MAP message has been described in detail with reference to FIG. 3.

While the second-level MAP message is transmitted only at the start of a data slot in the above description, it is clearly to be understood that the second-level MAP message can be transmitted at the start of any of slots including the RRM slot. That is, while only the first-level MAP message is transmitted at the start of the RRM slot in the embodiment of the present invention, the first-level and second-level MAP messages can be transmitted simultaneously at the start of the RRM slot.

In step 421, the BS determines whether the frame ends. If the frame still continues, the BS returns to step 415. If the frame ends, the BS terminates the procedure.

If the first-level MAP message is transmitted at the start of a frame and the second-level MAP message is transmitted at the start of each data slot as proposed in the present invention, real-time service may not be possible because the first-level MAP message can be received only at the start of the frame. Therefore, to provide real-time service according to a QoS (Quality of Service) level, the following method is provided.

(1) An MS, which initially accesses, cannot receive the first-level MAP message if an initial access point is not the start point of a frame. Therefore, the MS waits until the start point of the next frame irrespective of its QoS level to receive the first-level MAP message.

(2) When a data transmission/reception period is temporarily discontinued during real-time service and the data transmission/reception resumes, the MS cannot receive the first-level MAP message if a reconnection point for resuming data transmission/reception, that is, a fast access point is not the start point of a frame. Therefore, the BS, upon sensing a reconnection request for resuming the data transmission/reception for the real-time service, assigns resources to the MS at the reconnection request sensed time point and transmits resource allocation information to the MS at the next scheduling time point, that is, at the start of the next slot by the second-level MAP message.

The reconnection request is delivered to the BS on a feedback channel. The feedback channel delivers information about a CQI, the current buffer size of the MS, etc. When the MS determines that a resource allocation order or the amount of assigned resources is to be changed, it tells the request related to resource assignment to the BS on the feedback channel. The BS assigns resources corresponding with the resource assignment request and transmits resource allocation information to the MS by the second-level MAP message.

When the MS requests a reconnection for non-real-time service, it waits until the next frame as in the initial access. While QoS has been described separately with regard to real-time service and non-real-time service, it is obvious that the reconnection can be controlled according to various QoS levels available in the wireless communication system.

As described above, the BS receives a CQI such as indicating a downlink channel status from all MSs in an active state in every scheduling period in order to dynamically assign resources. However, as more MSs are in the active state, more uplink signals feed back CQIs, interfering each other. Consequently, system throughput gets worse.

In accordance with the present invention, the first-level MAP message and the second-level MAP message are transmitted separately, such that an MS can determine in advance a slot scheduled for the MS, that is, a slot in which to receive resource allocation information. Therefore, considering processing time in the BS, the BS controls the MS to transmit a feedback channel in the slot previous to that in which each MS receives resource allocation information by the second-level MAP message. Then the MS has only to feed back a CQI in an assigned slot rather than in each slot. Therefore, uplink resources for CQI feedback are saved, interference between uplink signals that feed back CQIs is eliminated, and transmit power consumption in MSs is minimized.

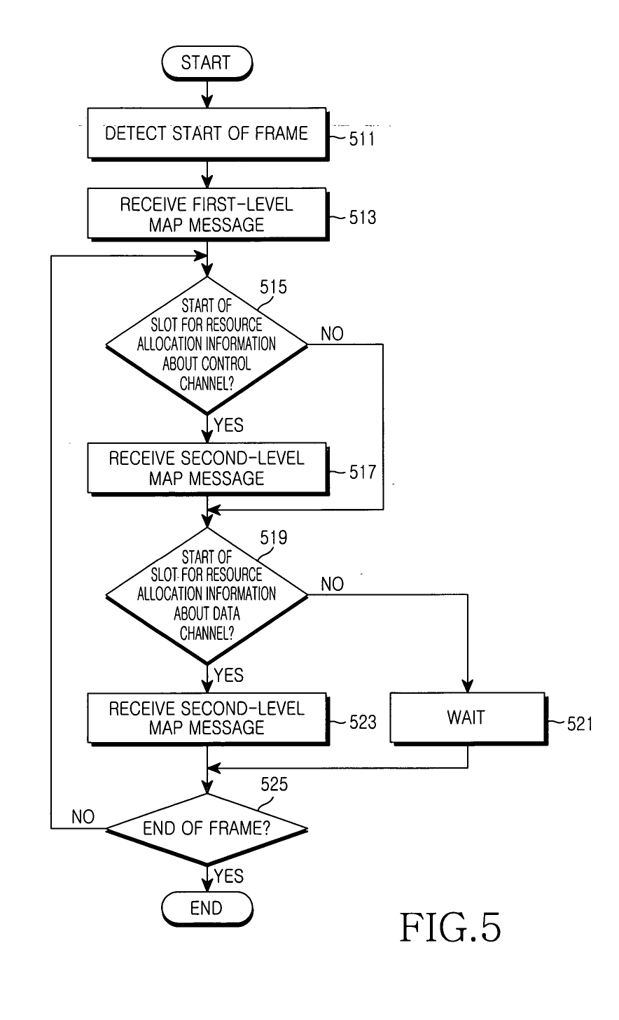

FIG. 5 is a flowchart illustrating the MS operation according to the present invention. Similar to the BS, the MS operation is repeated every frame. However, for conciseness, the MS operation for one frame will be described.

Referring to FIG. 5, the MS detects the start of a frame, specifically the start of an RRM slot in step 511 and receives the first-level MAP message at the start of the frame in step 513. Based on information in the first-level MAP message, the MS detects a slot in which to receive the second-level MAP message including resource allocation information about a control channel or a data channel to be assigned to the MS. Because the information of the first-level MAP message has been described with reference to FIG. 3, it will not be described again here.

In step 515, the MS determines, based on the information of the first-level MAP message, whether it is to receive resource allocation information regarding an assigned control channel at the start of a current slot. If the current slot is the slot in which the MS is supposed to receive the resource allocation information for the control channel, the MS receives the second-level MAP message at the start of the current slot and detects the resource allocation information in step 517.

After step 517 or if the current slot is the slot in which the MS is supposed to receive the resource allocation information for the control channel in step 515, in step 519, the MS determines, based on the information of the first-level MAP message, whether it is to receive resource allocation information regarding an assigned data channel at the start of a current slot. If the current slot is not the slot in which the MS is supposed to receive the resource allocation information for the data channel, the MS waits for the start of the slot having the resource allocation information for the data channel in step 521 and proceeds to step 525.

If the current slot is the slot in which the MS is supposed to receive the resource allocation information for the data channel, the MS receives the second-level MAP message and detects the resource allocation information for the data channel in step 523 and then proceeds to step 525. In step 525, the MS determines whether the frame ends. If the frame still continues, the MS returns to step 515. If the frame ends, the MS terminates the procedure.

While the MS first detects the start of a slot having resource allocation information for a control channel and then the start of a slot having resource allocation information for a data channel in the procedure of FIG. 5, the detection of the start points of the slots can be performed irrespective of the order.

In accordance with the present invention as described above, the wireless communication system produces resource allocation information at each of multiple levels and transmits/receives it, thereby minimizing the signaling overhead from the transmission/reception of resource allocation information and resource consumption, and power consumption in an MS is minimized.

While the present invention has been shown and described with reference to certain preferred embodiments thereof, it will be understood by those skilled in the art that various changes in form and details may be made therein without departing from the spirit and scope of the present invention as defined by the appended claims.

1. A method of transmitting resource allocation information in a base station (BS) in a wireless communication system, comprising the steps of:
transmitting first resource allocation information at every predetermined first time point of a first period, the first resource allocation information being common to all mobile stations (MSs); and
transmitting second resource allocation information at every predetermined second time point of a second period within the first period, the second resource allocation information being dedicated to each of the MSs at a second time point of the second period predetermined for each of the MSs and the second period being shorter than the first period.

2. The method of claim 1, wherein the first resource allocation information includes information indicating a second time point of the second period for each of the MSs, the information being monitored by all the MSs to receive the second resource allocation information.

3. The method of claim 1, wherein the second resource allocation information includes information about a channel assigned to each of the MSs.

4. The method of claim 1, wherein the first period is a frame duration and the second period is a slot duration.

5. The method of claim 1, wherein the first period is a super frame duration and the second period is a frame duration.

6. The method of claim 1, further comprising the steps of:
assigning resources to an MS requiring a quality of service (QoS) level higher than a predetermined QoS level, upon detecting an additional resource assignment request from the MS at a time point set within the first period, other than the first time point of the first period; and
transmitting, to the MS, second resource allocation information including information about the additionally assigned resources at an earliest of the second time points of the second period.

7. A method of receiving resource allocation information in a mobile station (MS) in a wireless communication system, comprising the steps of:
receiving first resource allocation information that is common to all MSs at every first predetermined time point of a first period; and
receiving second resource allocation information that is dedicated to each of the MSs at a predetermined second time point of a second period among second time points of the second period defined within the first period by analyzing the first resource allocation information, the second period being shorter than the first period.

8. The method of claim 7, wherein the first resource allocation information includes information indicating the predetermined second time point of the second period, the information being monitored by all the MSs to receive the second resource allocation information.

9. The method of claim 7, wherein the second resource allocation information includes information about a channel assigned to each of the MSs.

10. The method of claim 7, wherein the first period is a frame duration and the second period is a slot duration.

11. The method of claim 7, wherein the first period is a super frame duration and the second period is a frame duration.

12. The method of claim 7, further comprising the steps of:
determining if additional resource allocation is needed at a time point set within the first period, other than the first time point of the first period and
transmitting an additional resource assignment request to a base station (BS), when additional resource allocation is needed.

13. The method of claim 12, wherein the additional resource assignment request is transmitted on a feedback channel.

14. The method of, claim 12, further comprising the step of transmitting feedback information required for the resource assignment to the BS at a second time point previous to the predetermined second time point of the second period by analyzing the first resource allocation information.

15. The method of claim 14, wherein the feedback information is transmitted on the feedback channel.

16. A wireless communication system for transmitting and receiving resource allocation information, comprising:
a base station (BS) for transmitting first resource allocation information at every predetermined first time point of a first period, the first resource allocation information being common to all mobile stations (MSs), and transmitting second resource allocation information at every predetermined second time point of a second period within the first period, the second resource allocation information being dedicated to each of the MSs at a second time point of the second period predetermined for each of the MSs and the second period being shorter than the first period; and
an MS for receiving the first resource allocation information at every first predetermined time point of the first period, and receiving second resource allocation information dedicated to the MS at a second time point of the second period predetermined for the MS by analyzing the first resource allocation information.

17. The system of claim 16, wherein the first resource allocation information includes information indicating the second time point of the second period for each of the MSs, the information being monitored by all the MSs to receive the second resource allocation information.

18. The system of claim 16, wherein the second resource allocation information includes information about a channel assigned to each of the MSs.

19. The system of claim 16, wherein the first period is a frame duration and the second period is a slot duration.

20. The system of claim 16, wherein the first period is a super frame duration and the second period is a frame duration.

21. The system of claim 16, wherein if the MS determines that additional resource allocation is needed at a time point set within the first period, other than the first time point of the first period, the MS transmits an additional resource assignment request to the BS.

22. The system of claim 21, wherein the MS transmits the additional resource assignment request on a feedback channel.

23. The system of claim 21, wherein the BS determines whether the MS requires a quality of service (QoS) level higher than a predetermined QoS level, upon receipt of the additional resource assignment request from the MS at the time point set within the first period, other than the first time point of the first period, additionally assigns resources to the MS if the MS requires the QoS level higher than the predetermined QoS level, and transmits, to the MS, second resource allocation information including information about the additionally assigned resources at the earliest of the second time points of the second period.

24. The system of claim 16, wherein the MS transmits feedback information required for the resource assignment to the BS at a second time point previous to the predetermined second time point of the second period by analyzing the first resource allocation information.

25. The system of claim 24, wherein the MS transmits the feedback information on a feedback channel.
